(19) United States
(12) Patent Application Publication
(10) Pub. No.: US 2010/0314363 A1
(43) Pub. Date: Dec. 16, 2010

(54) Laser nozzle tips

(76) Inventor: Roger Blaine Trivette, Boiling Springs, SC (US)

Correspondence Address: MONAHAN & MOSES, LLC, 13-B W. WASHINGTON ST., GREENVILLE, SC, 29601, US

(21) Appl. No.: 12/456,187

(22) Filed: Jun. 12, 2009

(51) Int. Cl. B23K 26/38

(52) U.S. Cl. 219/121.67

(57) ABSTRACT

An injection molded laser cutting nozzle tip made from an electrically conductive polymer is provided. Suitable electrically conductive polymers include, but are not limited to, polyphenylene sulfide (PPS), polyaniline, polythiophene, polypyrrole, and polyacetylene.

### BACKGROUND OF THE INVENTION

The present invention relates generally to novel nozzle tips for laser cutting devices. More specifically, the present invention relates to laser cutter nozzle tips made from polymeric material that is electrically and thermally conductive.

Laser cutting is a technology that uses a laser to cut materials, which is used in the production line and is typically used for industrial manufacturing applications. Laser cutting works by directing the output of a high power laser, by computer, at the material to be cut. The material then either melts, burns, vaporizes away, or is blown away by a jet of gas, leaving an edge with a high quality surface finish.

Laser cutting machines typically include a laser cutting head with a nozzle at the end adjacent the workpiece to be cut. The laser cutting head includes a lens system that focuses the laser beam through an aperture in the nozzle. To obtain uniform cutting action, it is necessary for the focal point of the laser beam to be at an optimum distance from the surface of the workpiece. If the workpiece to be cut is not perfectly flat, it is necessary for the focal point of the beam and generally the entire laser cutting head, to be moved upwardly and downwardly to maintain the desired spacing of the focal point relative to the surface of the workpiece.

Most laser cutting machines employ an electrically conductive nozzle tip, typically made from copper or some other metal. At the beginning of a cutting operation, the nozzle is lowered until it comes into contact with the workpiece to be cut. At the point where the nozzle tip comes into contact with the workpiece, the machine senses such contact via an electrical connection between the machine and the nozzle, the machine raises the nozzle to a predetermined, optimal level above the workpiece to commence the cutting process. During the cutting process, if the nozzle tip comes into contact, the machine also senses that contact and shuts down the machine, as a built-in safety measure. Such contact between the nozzle tip and the workpiece during the cutting operation may damage the nozzle tip, but the safety mechanism is designed to protect the laser lens and head, which is an expensive component of the laser cutting machine.

Because laser cutting nozzle tips in the above-described laser cutting machines must be electrically conductive, they are typically made from copper or some other metal. Such metal nozzle tips are replaced often for various reasons, sometimes in order to change sizes or shapes, or simply due to damage or wear and tear. Copper nozzle tips are relatively expensive, and the cost of constantly replacing such nozzle tips may be significant.

Therefore, it would be desirable to provide a laser cutting nozzle tip that is inexpensive to manufacture, and which is easy to replace within the laser cutting machine. Further, it would be desirable to provide a laser cutting nozzle tip that could be manufactured by injection molding, using an electrically and thermally conductive polymer material.

### BRIEF SUMMARY OF THE INVENTION

In accordance with one aspect of the invention, a laser cutting nozzle tip made from an electrically and thermally conductive polymer is provided. The nozzle tip is used with a laser cutting apparatus directing a focused beam to a spot on a work piece. The nozzle tip has a generally cylindrical body with a conical section. The interior of the nozzle tip is shaped to match the profile of the laser beam at full beam width, which passes through the nozzle to the work piece. The size of the cone is determined by the full beam width of the laser so that the converging beam profile just fits inside the cone. The laser beam can, of course, be apertured down if desired. The nozzle tip body includes a threaded portion allowing the nozzle tip to be screwed into a receptacle that holds the nozzle tip in place.

The preferred material for the manufacture of the nozzle tip is an electrically and thermally conductive polymer. One preferred material is the COOLPOLYMER E-Series, which is both electrically and thermally conductive, and is sold by Cool Polymers, Inc, located in Warwick, R.I. In general terms, conductive polymers that may be used include polyphenylene sulfide (PPS), polyaniline, polythiophene, polypyrrole, and polyacetylene, and derivatives thereof. Although specific polymers have been listed as suitable materials for the manufacture of laser nozzle tips described herein, it is contemplated that other electrically conductive polymers may be suitable for such use, so long as they can withstand the heat and air pressure produced during a laser cutting operation without significantly degrading the electrical conductivity or the structural integrity of the nozzle tip under such conditions.

These types of laser cutting nozzles may be mass manufactured inexpensively and efficiently by injection molding, thus reducing the cost per nozzle significantly. Additionally, in some cases, when the nozzle tip comes into contact with a work piece during a laser cutting operation, the polymeric nozzle tip is essentially destroyed, which provides an additional safety feature to protect the rest of the nozzle and the laser head itself.

### BRIEF DESCRIPTION OF THE DRAWINGS

These and other features, aspects, and advantages of the present invention will become better understood with regard to the following description, appended claims, and accompanying drawings where:

FIG. 1 is a side view of one embodiment of a polymeric laser cutting nozzle tip;

FIG. 1A is a cross sectional view along the line A-A of FIG. 1; and

FIG. 2 is a top view of one embodiment of a polymeric laser cutting nozzle tip.

### DETAILED DESCRIPTION OF THE INVENTION

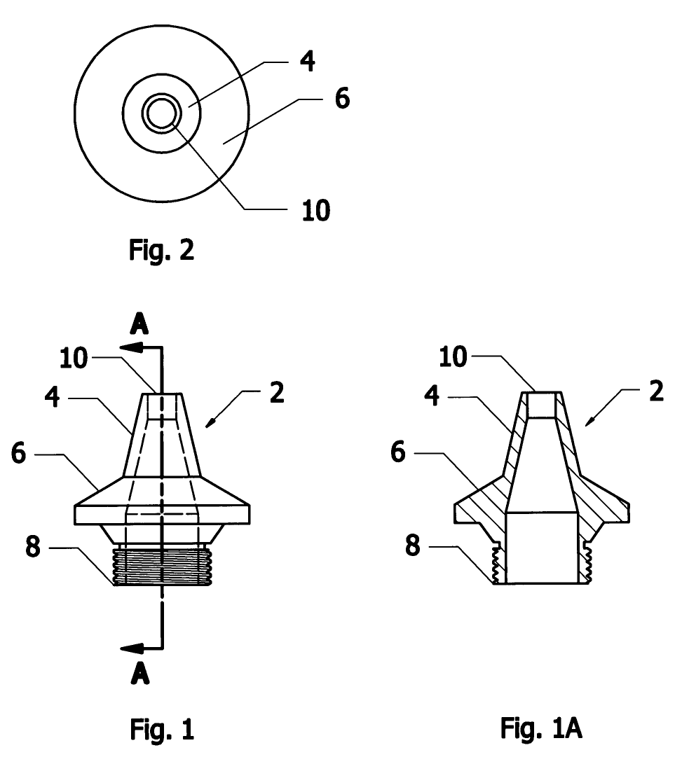

A first embodiment of the polymeric laser cutter nozzle tip is illustrated in FIGS. 1-3. The nozzle tip 2 includes a main body member 6 having a conical section 4 with an orifice 10 at the narrow portion of the conical section 4. The main body member 6 is formed into a cylindrical shape with a flange around an outer portion thereof, and includes threads 8 on an outer periphery thereof. These threads 8 are used to screw the nozzle tip into a receptacle on a nozzle assembly for a laser cutting machine. The interior of the nozzle tip 2 is shaped conically at one end to match the profile of the laser beam at full beam width, which passes through the nozzle tip 2 to the work piece. The size and shape of the conical section 4 is determined by the full beam width of the laser so that the converging beam profile just fits inside the cone. The laser beam can, of course, be aperture down if desired.

It is to be understood that nozzle tips may have various shapes and sizes, in order to fit various laser cutting nozzle assemblies, and that the embodiment shown and described herein is but one example of a laser nozzle tip made in accordance with the present invention. Typically, laser nozzle tips will have a threaded portion to mate with the rest of the laser nozzle assembly, although other attachment means may be used, such as a separate threaded collar holding the nozzle tip in place. Additionally, the typical laser nozzle tip will include a conical shape, although other shapes may be suitable. In order to form an electrical connection between the nozzle tip and the laser nozzle assembly, there are many methods and arrangements providing for such a connection, and these methods and arrangements are well known in the art. For example, U.S. Pat. No. 6,025,571 describes one such design, and is hereby incorporated herein by reference.

The preferred material for the manufacture of the nozzle tip is an electrically and thermally conductive polymer. One preferred material is the COOLPOLYMER E-Series, which is both electrically and thermally conductive, and is sold by Cool Polymers, Inc, located in Warwick, R.I. In general terms, conductive polymers that may be used include polyphenylene sulfide (PPS), polyaniline, polythiophene, polypyrrole, and polyacetylene, and derivatives thereof. Although specific polymers have been listed as suitable materials for the manufacture of laser nozzle tips described herein, it is contemplated that other electrically conductive polymers may be suitable for such use, so long as they can withstand the heat and air pressure produced during a laser cutting operation without significantly degrading the electrical conductivity or the structural integrity of the nozzle tip under such conditions.

The preferred manufacturing method for the polymeric laser cutting nozzle tip is injection molding. It is contemplated that such nozzle tips made from electrically and thermally conductive polymeric materials may be made in any desired shape and size.

One additional advantage to providing an injection molded laser cutting nozzle tip made from an electrically conductive polymer is based on sacrificial engineering. If, during the course of a cutting process, a nozzle tip comes into contact with a work piece, the machine may sense an electrical short circuit caused by such contact and will shut down the cutting operation. However, occasionally, because the nozzle tip is in motion when such contact occurs, the entire laser nozzle assembly may be bent or broken by the force of the nozzle motion against the work piece, even if the laser has been shut down, because the metal nozzle tip would not break off of the assembly. By using electrically conductive polymers, however, the nozzle tip is engineered to simply break against such force, leaving the rest of the nozzle head (which includes expensive components such as the laser head) intact. In such a case, it is not necessary to replace the entire laser cutting nozzle assembly, rather only the inexpensive polymeric nozzle tip is replaced.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A nozzle tip for use with a laser cutting machine, said nozzle tip comprising:
a main body member including a generally conical section, wherein said nozzle tip is manufactured by injection molding using an electrically conductive polymer.

2. The nozzle tip set forth in claim 1, wherein said main body member includes a threaded portion for attachment to a laser nozzle assembly.

3. The nozzle tip set forth in claim 1, wherein said electrically conductive polymer is selected from the group consisting of polyphenylene sulfide (PPS), polyaniline, polythiophene, polypyrrole, and polyacetylene.
